(19) United States
(12) Patent Application Publication
(10) Pub. No.: US 2014/0265593 A1
(43) Pub. Date: Sep. 18, 2014

(54) METHODS AND APPARATUS FOR A POWER STORAGE AND DELIVERY SYSTEM

(71) Applicants: John D. Hensler, Phoenix, AZ (US); Brett Hensler, Hermosa Beach, CA (US)

(72) Inventors: John D. Hensler, Phoenix, AZ (US); Brett Hensler, Hermosa Beach, CA (US)

(21) Appl. No.: 13/830,659

(22) Filed: Mar. 14, 2013

(51) Int. Cl. H02J 4/00

(52) U.S. Cl. CPC H02J 4/00
USPC 307/66

(57) ABSTRACT

Methods and apparatus for a power storage and delivery system according to various aspects of the present invention generally comprise receiving a first electric current from one or more sources, storing energy derived from the electric current in a magnetic capacitor, releasing the stored energy as a second electric current, and providing the second electric current to a residential property, commercial property, or any other structure with similar electrical needs. The systems and methods of the present invention may be capable of operating as the sole provider of electric current to a structure for multiple days without the assistance of another source of electric current.

### BACKGROUND OF THE INVENTION

Backup power supply systems often comprise basic energy storage devices, such as lead-acid batteries. If the main source of power for an electrical load connected to a backup power supply system fails or behaves abnormally, the backup power supply system may supply power to the load in place of the main power source. Such backup systems, however, are only capable of providing power to the load for a few seconds to a few hours. Further, such systems may charge their energy storage devices from the electrical grid during time periods which are not the most cost effective. Backup power supply systems designed to supply power to an entire residential or commercial property are large and are still only capable of providing power for a few seconds to a few hours.

### SUMMARY OF THE INVENTION

Methods and apparatus for a power storage and delivery system according to various aspects of the present invention generally comprise receiving a first electric current from one or more sources, storing energy derived from the electric current in a magnetic capacitor, releasing the stored energy as a second electric current, and providing the second electric current to a residential property, commercial property, or any other structure with similar electrical needs. The systems and methods of the present invention may be capable of operating as the sole provider of electric current to a structure for multiple days without the assistance of another source of electric current.

### BRIEF DESCRIPTION OF THE DRAWING FIGURES

FIG. 1 representatively illustrates a power storage and delivery system in accordance with an exemplary embodiment of the present invention;

FIG. 2 representatively illustrates a power storage and delivery system in accordance with a second exemplary embodiment of the present invention;

FIG. 3 representatively illustrates a protective enclosure for housing multiple removable cards in accordance with an exemplary embodiment of the present invention;

FIG. 4A representatively illustrates a power storage and delivery system within a larger electrical network comprising a direct current source in accordance with an exemplary embodiment of the present invention;

FIG. 4B representatively illustrates a power storage and delivery system within a larger electrical network comprising an alternating current source in accordance with an exemplary embodiment of the present invention;

FIG. 4C representatively illustrates a power storage and delivery system within a larger electrical network comprising an alternating current source and a direct current source in accordance with an exemplary embodiment of the present invention; and

FIG. 5 representatively illustrates a flowchart for the delivery of stored power.

Elements and steps in the figures are illustrated for simplicity and clarity and have not necessarily been rendered according to any particular sequence. For example, steps that may be performed concurrently or in a different order may be illustrated in the figures as a sequence to improve understanding of the described embodiments of the present invention.

Elements, operational features, applications, and/or advantages are illustrated by certain exemplary embodiments recited in the disclosure. Representative elements, operational features, applications, and/or advantages of the present invention reside in the details of construction and operation as more fully described or otherwise identified. The description may refer to the accompanying drawings, images, figures, etc., wherein like numerals (if any) refer to like parts throughout.

### DETAILED DESCRIPTION OF EXEMPLARY EMBODIMENTS

Various aspects of the present invention may be described in terms of functional block components and various processing steps. Such functional blocks may be realized by any number of hardware or software components configured to perform the specified functions and achieve the various results. For example, the present invention may employ processors, controllers, sensors, detectors, electrical connectors and interfaces, DC-AC inverters, rectifiers, active power factor correction (“APFC”) circuits, DC-DC converters, switches, user interface devices, communication interfaces, energy storage devices such as magnetic capacitors, and the like, which may carry out a variety of functions.

In addition, various aspects of the present invention may be practiced in conjunction with any number of residential or commercial electricity distribution systems, electricity distribution systems of other structures or properties having electrical needs similar to or greater than those of a residential or commercial property, backup power supply systems, sources of electricity such as mains electricity and renewable energy sources, communication and/or interface devices, and the systems and methods described are merely exemplary applications for the invention. Further, the present invention may employ any number of conventional techniques for receiving and providing an electrical current, storing energy, controlling the storage of energy, determining the cost of receiving an electrical current, outputting information regarding any of the above, and the like. Further, the present invention may employ any number of conventional techniques for converting alternative current (“AC”) to direct current (“DC”), DC to AC, one form of DC to another form of DC, one form of AC to another form of AC, and the like.

A power storage and delivery system according to various aspects of the present invention may be capable of providing electricity to a structure for multiple days without the assistance of another power source. A power storage and delivery system according to various aspects of the present invention may be capable of operating as the primary power source for a structure, may selectively recharge at utility off-peak hours to help minimize the cost of electricity usage, may help reduce and/or mitigate power surges, and may help flatten the utility power grid supply and/or demand curve. A power storage and delivery system according to various aspects of the present invention may operate as a back-up system by storing sufficient energy to provide a user with electricity over a period of days, for example during a brownout or blackout.

A power storage and delivery system according to various aspects of the present invention may be capable of storing 50 kWh to several megawatt hours or more of energy. An exemplary power storage and delivery system according to various aspects of the present invention may be contained in an enclosure approximately 10 inches×12 inches×8 inches, may provide approximately 120 kWh of energy storage, may take approximately six hours to fully charge from empty, and may charge as quickly as the available power sources permit. An exemplary power storage and delivery system may comprise heat sinks, fans, and/or other systems and methods of dissipating generated and/or accumulated heat.

Various representative implementations of the present invention may be applied to any system for supplying and/or using an electric current. Certain representative implementations may include, for example, a magnetic capacitor collecting, retaining, and releasing energy derived from an AC source, a magnetic capacitor collecting, retaining, and releasing energy derived from a DC source, and the like. Referring to FIG. 1, a power storage and delivery system 100 may comprise a supply input 105, an energy storage module 110, a DC-AC inverter 115, a mains output 120, a controller 140, a capacitor management system (“CMS”) 150, and a communication interface 145.

The supply input 105 accepts an electric current from an electric current source external to the power storage and delivery system 100. The supply input 105 may comprise any system configured to electrically connect with an electrical conductor capable of delivering an electric current, such as AC and/or DC. The supply input 105 may comprise any suitable electrically conductive material. In one embodiment, the supply input 105 may comprise a screw terminal configured to electrically connect to a wire. In another embodiment, the supply input 105 may comprise a twist-on wire connector, sometimes referred to as a “wire nut.” In another embodiment, the supply input 105 may comprise one connector of a suitable male-female pair of electrical connectors.

In one embodiment, the supply input 105 may be configured to electrically connect with one or more wires delivering mains electricity from one or more sources such as an electric utility. For further example, the supply input 105 may be configured to electrically connect with one or more wires delivering electricity from a solar panel, wind turbine, and the like. The power storage and delivery system 100 may comprise multiple supply inputs 105, wherein each supply input 105 may be individually configured to accept a source of electric current. For example, the power storage and delivery system 100 may comprise a first supply input 105 configured to accept AC current from an electric utility, and a second supply input 105 configured to accept DC current from a solar panel.

The mains output 120 delivers an electric current to an electric load external to the power storage and delivery system 100. The mains output 120 may comprise any system configured to electrically connect with an electrical conductor capable of delivering an electric current. For example, the mains output 120 may be configured to electrically connect with one or more wires leading to a household circuit breaker panel. The mains output 120 may comprise any suitable connector such as a screw terminal configured to electrically connect to a wire, a wire nut, or a suitable male-female pair of electrical connectors. The power storage and delivery system 100 may comprise multiple mains outputs 120, wherein each mains output 120 may be individually configured to deliver an electric current. The mains output 120 may comprise any suitable electrically conductive material.

The DC-AC inverter 115 converts DC to AC. The DC-AC inverter 115 may comprise any system or device configured to change DC to AC. The DC-AC inverter 115 may accept any DC voltage as an input, and may output AC at any suitable voltage and frequency. The DC-AC inverter 115 may be electrically coupled with the mains output 120 to provide the output AC to the mains output 120. The DC-AC inverter 115 may be configured to produce any type of AC waveform, such as square wave, modified sine wave, pure sine wave, and the like. In one embodiment, the DC-AC inverter 115 may produce a pure sine wave AC at a voltage acceptable for use by a residential or commercial property, such as 120V or 208V.

The DC-AC inverter 115 may comprise sensors and/or other electronics to detect the state of the DC-AC inverter 115, and may be configured to communicate the sensed state to another device. For example, the DC-AC inverter 115 may comprise sensors to determine and/or detect the total harmonic distortion (“THD”) of the output AC waveform, and may be configured to electronically communicate information relating to the THD using a communication port or other output of the DC-AC inverter 115. The DC-AC inverter 115 may further comprise sensors to determine and/or detect information related to the health of the DC-AC inverter 115, and may be configured to communicate related information using a communication port or other output of the DC-AC inverter 115.

The energy storage module 110 collects, retains, and releases energy using a magnetic capacitor (“MCAP”). The energy storage module 110 may comprise any system configured to receive an electric current, collect and retain energy derived from the received electric current using the MCAP, and generate an electric current through the release of the energy retained in the MCAP. The energy storage module 110 may comprise an input configured to receive an electric current that may be retained as energy in the MCAP and an output configured to deliver an electric current generated by the release of retained energy from the MCAP. In one embodiment, the energy storage module 110 input may be electrically coupled with the supply input 105, and the energy storage module 110 output may be electrically coupled with the DC input of the DC-AC inverter 115. The energy storage module 110 input may be electrically coupled with the MCAP to facilitate the retention of energy, derived from the received electric current, in the MCAP. The MCAP may be electrically coupled with the energy storage module 110 output to facilitate the delivery of electric current generated by the release of the retained energy. The energy storage module 110 may further comprise a plurality of MCAPs electrically coupled with the energy storage module 110 input and output, and configured to collect, retain, and release energy. The plurality of MCAPs may be electrically coupled in a series configuration, parallel configuration, or any other suitable configuration.

The MCAP may comprise a dielectric positioned between a first layer of conducting magnetic material and a second layer of conducting magnetic material, wherein the magnetic polarization of at least one layer of conducting magnetic material is controllable. The MCAP may collect, retain, and release energy based on a signal. The signal may comprise any suitable electronic signal that directly or indirectly causes the MCAP to collect, retain, and/or release energy. In one embodiment, the signal may comprise the control of the magnetic polarization of at least one of the layers of conducting magnetic materials. For example, the signal may comprise causing the magnetic polarization of the first and second layers of conducting magnetic material to be opposite from each other to allow the MCAP to collect or release energy. To retain energy, the signal may comprise causing the magnetic polarization of the first and second layers of conducting magnetic material to be the same. Collecting energy may comprise charging the MCAP using an electric current, and releasing energy may comprise discharging the MCAP to generate an electric current. Other types of magnetic capacitors, whether now known or later developed, may be used.

In one embodiment, a plurality of MCAPs may be controlled individually, for example by providing each MCAP with a unique signal. Alternatively, in a second embodiment, the plurality of MCAPs may be controlled in groups, for example by providing the same signal to each MCAP in a group of MCAPs. In a third embodiment, the plurality of MCAPs may be controlled as a collective whole, for example by providing the same signal to each of the plurality of MCAPs. In yet another embodiment, the plurality of MCAPs may be controlled by any combination of the above.

The energy storage module 110 may comprise one or more sensors to determine the status of the MCAP. For example, the energy storage module 110 may comprise a sensor configured to measure the energy being collected, retained, and/or released by the MCAP, measure characteristics of the electric current, such as amperage or voltage, being received by or output from the MCAP, measure the electrical potential difference (or voltage) between two terminals of the MCAP, and/or measure a temperature of or proximate to the MCAP. In some embodiments, the energy storage module 110 may comprise a plurality of MCAPs and any suitable configuration of sensors to determine the status of each individual MCAP, a group of MCAPs, the entire plurality of MCAPs, or any combination thereof.

The supply input 105, energy storage module 110, DC-AC inverter 115, and mains output 120 may be collectively referred to as the power electronics 130. The electrical coupling between the various components of the power electronics 130 may comprise any electrically conductive material, or any combination of electrically conductive materials. In addition, while the various components of the power electronics 130 have been described as being electrically coupled with other components, the coupling may be accomplished through one or more intermediary electronic components.

The CMS 150 monitors the MCAP and generates the signal to control the collection, retention, and release of energy by the MCAP. The CMS 150 may comprise any suitable hardware and/or software device or system configured to generate the signal to control the MCAP. The CMS 150 may monitor each MCAP individually, may monitor groups of MCAPs, may monitor the collective plurality of MCAPs, or any combination thereof. The CMS 150 may be communicatively linked with the energy storage module 110 and/or the MCAP. The communicative link between the CMS 150 and the energy storage module 110 and/or the MCAP may facilitate the conveyance of the signal generated by the CMS to the MCAP. The communicative link between the CMS 150 and the energy storage module 110 may facilitate the conveyance of information relating to the MCAP from the energy storage module 110 to the CMS 150. For example, information relating to the status of the MCAP determined by the one or more sensors of the energy storage module 110 may be conveyed from the energy storage module 110 to the CMS 150 using the communicative link.

The CMS 110 may use the received information relating to the MCAP to determine additional information relating to the MCAP and/or generate an appropriate signal to control the MCAP. For example, the CMS 110 may use the received information to determine the state of charge of the MCAP, and in response may generate a signal to cause the MCAP to retain energy if the CMS 110 determines that the MCAP is fully charged, and may generate a signal to cause the MCAP to collect energy if the CMS 110 determines that the MCAP is not fully charged.

The controller 140 monitors the status of and controls the power storage and delivery system 100. The controller may be configured to determine when to collect, retain, and/or release energy using the energy storage module 110. The controller 140 may comprise any suitable system configured to monitor the electric current being delivered through the mains output 120, monitor the electric current being delivered through the supply input 105, and/or determine an amount of energy delivered through the mains output 120 and/or supply input 105 based on the appropriate monitored electric current.

The electric current may be sensed, detected, or otherwise determined by one or more sensors. For example, the electric current being delivered through the mains output 120 and/or the supply input 105 may be sensed by using a Hall effect sensor suitably positioned near the mains output 120 and/or supply input 105, and electrically coupled with the controller to provide the sensed information to the controller. Alternatively, the Hall effect sensor may be positioned to measure the current output by the DC-AC inverter 115 instead of or in addition to the current delivered through the mains output 120, as these two currents may be substantially equal. In some embodiments, the controller 140 may be configured to determine an efficiency of the power storage and delivery system 100 based at least partially on the sensed current being delivered through the supply input 105 and the mains output 120.

The controller 140 may be communicatively linked with a communication interface 145. The communication interface 145 may provide an interface with external devices and/or communication networks. For example, the communication interface 145 may provide a wired or wireless connection to a computer network, such as a local area network, wide area network, an intranet, the Internet, and the like. For further example, the communication interface 145 may provide a wireless connection to a cellular radio network, such as one using CDMA, TDMA, 3G, 4G LTE, and the like. In one embodiment, the communication interface 145 may comprise a wireless network device. In another embodiment, the communication interface 145 comprises an Ethernet adapter. For example, the communication interface 145 may facilitate a network connection with the Internet and may facilitate the retrieval of utility rate information from a computerized device connected to the Internet, such as a computer database. The communication interface 145 may provide a connection to an external memory device, such as a computer database, a USB thumb drive, and the like. For example, the communication interface 145 may comprise a USB port configured to facilitate the connection and transfer of utility rate information from a USB thumb drive to the controller 140.

The controller 140 may be configured to provide a one- or two-way user interface using the communication interface 145. The user interface may be adapted to present information relating to electricity usage and cost statistics, past, present, and/or future utility rate information, status of any component of the power storage and delivery system 100, state of charge of the MCAP, charge, retention, and/or discharge status, whether one or more electric current sources are experiencing an unusual condition and/or other predetermined conditions, and the like. The controller 140 may provide any suitable information available to the controller 140 over the communication interface 145. In one embodiment, the controller 140 may be configured to provide a website or web page comprising information related to the status of the power storage and delivery system 100. The controller 140 may be configured to provide status information, using the communication interface 145, to a software application executing on a computing device, or a database. For example, the controller 140 may send statistics related to user savings and other related information to a computer database.

The controller 140 may be electrically coupled with the DC-AC inverter 115. The DC-AC inverter 115 may deliver or otherwise provide information relating to the DC-AC inverter 115 to the controller 140 via the electrical coupling. In an exemplary embodiment, the DC-AC inverter 115 may be configured to provide information relating to THD to the controller 140. The DC-AC inverter 115 may be configured to provide information relating to the overall health or specific aspects of the health of the DC-AC inverter 115 to the controller 140.

The controller 140 may be communicatively linked with the CMS 150. The CMS 150 may communicate information to the controller 140 relating to the status of the MCAP. In an exemplary embodiment, the CMS 150 provides the controller 140 with information relating to the state of charge of the MCAP. The controller 140 may provide information or commands to the CMS 150 corresponding to the need or desire to collect, retain, or release energy.

The controller 140 may be configured to access utility rate information corresponding to one of the sources of electric current the supply input is configured to accept, using the communication interface 145. The controller 140 may be configured to determine a time period in which the MCAP should charge. For example, it may be more desirable to charge the MCAP during a period of lowest cost for a source of electric current, and the controller 140 may be configured to determine the lowest cost time period in which the MCAP should charge. The controller 140 may use such a determination to instruct the CMS 150 to cause the collection of energy only during the predetermined period. Similarly, it may be desirable to provide electric current to the mains output 120 from the energy storage module 110 during the highest cost time periods, and the controller 140 may instruct the CMS 150 to cause the release of energy during such predetermined periods.

The controller 140 may be configured to provide or may be provided with a real-time clock. The real-time clock may allow the controller 140 to determine time. The controller 140 may comprise a system or device configured to provide the real-time clock. The controller 140 may be configured to use the real-time clock to determine the predetermined periods, and may be configured to use the real-time clock to determine when one or more of the predetermined periods are occurring. For example, the controller 140 may be configured to recognize the current time based on the real-time clock, and may be configured to recognize if a predetermined period is occurring at the current time. The controller 140 may be configured to use the recognition of the current time and/or the occurrence or non-occurrence of a predetermined period to appropriately control the MCAP to collect, retain, and/or release energy, for example based on the retrieved utility rate information.

In some embodiments, the power storage and delivery system 100 comprises a plurality of supply inputs 105 configured to accept separate sources of electric current. The controller 140 may be configured to appropriately instruct the CMS 150 to cause the collection of energy during a predetermined period preferentially or only from a particular source. For example, the controller 140 may be configured to instruct the CMS 150 to cause the collection of energy only from the source of electric current having the lowest cost during a particular time period, or to cause the collection of energy from multiple sources of electric current during a predetermined period.

The power storage and delivery system 100 may be configured to route a source of electric current supplied to the supply input 105 to the mains output 120. For example, the controller 140 may determine that during a predetermined period, the MCAP is fully charged. In this case, the controller 140 may appropriately control the power storage and delivery system 100 to directly route the current from the supply input 105 directly to the mains output 120. Similarly, the controller 140 may determine that during a predetermined period, the MCAP is only partially charged and that a portion of the electric current being delivered to the supply input 105 can be routed directly to the mains output 120, and a second portion of the electric current being delivered to the supply input 105 can be used to charge the MCAP. In this example, the controller 140 may instruct the CMS 150 to cause the collection of energy during the predetermined period. In some embodiments, the power storage and delivery system 100 may be configured to route a source of electric current supplied to the supply input 105 to the mains output 120 through any intermediary component.

The CMS 150 may receive instructions from the controller 140 relating to the charging, retention of energy, and discharging of the MCAP. The CMS 150 may act directly on the received instructions and generate the appropriate signal to control the MCAP as instructed, or may use the received instructions in combination with other information to generate the signal to control the MCAP. In some embodiments, the CMS 150 may generate the signal to control the MCAP without regard to any instruction from the controller 140. For example, the controller may determine that it will be cheaper to deliver electric current from the energy storage module 110 to the mains output 120 and may instruct the CMS 150 to cause the release of energy from the energy storage module 110. The CMS 150 may determine that the state of charge of the MCAP is too low to provide sufficient electric current through the release of energy, and may generate the signal causing the MCAP to instead collect energy, and the controller 140 to route the electric current delivered to the supply input 105 to the mains output 120.

The CMS 150 and controller 140 may comprise the same hardware and/or software system, or they may comprise discrete hardware and/or software systems. The functions of the CMS 150 and controller 140 described above may be divided or combined among the CMS 150 and controller 140 in any combination. In one embodiment, the CMS 150 may comprise software executing on a processor of the controller 140. In these and other exemplary embodiments, the communicative link between the CMS 150 and the controller 140 may comprise the use of computer memory, a software function call, a hardware interrupt signal, and the like. In some embodiments, the communicative link between the controller 140 and the communication interface 145 may comprise the use of computer memory, a software function call, a hardware interrupt signal, and the like.

The CMS 150, controller 140, and communication interface 145 may be collectively referred to as the control electronics 160. The various components of the control electronics 130 have been described as being electrically coupled or communicatively linked with other components, and the electric coupling and/or communicative linking may be accomplished indirectly through one or more intermediary electronic components.

Referring now to FIG. 2, the power storage and delivery system 100 may comprise a contactor 205. The contactor 205 may comprise any system configured to facilitate connection and disconnection between an input to the contactor 205 and an output of the contactor 205. For example, the contactor 205 may comprise a switch configured to operate in response to a control signal. Exemplary operations of the contactor 205 may comprise electrically opening and/or closing. An input of the contactor 205 may be electrically coupled with the supply input 105, and an output of the contactor 205 may be electrically coupled with the energy storage module 110. The contactor 205 may also be electrically coupled with the controller 140, and the controller 140 may be configured to provide the contactor control signal. The controller 140 may be configured to control the contactor 205 in any suitable manner, for any suitable purpose. For example, the controller 140 may determine that during a predetermined period, the cost of using electric current from a source of electric current coupled to the supply input 105 is too high, and may then control the contactor 205 to open, thereby disconnecting the rest of the power storage and delivery system 100 from the source of electric current.

The power storage and delivery system 100 may further comprise a rectifier 210. The rectifier 210 may comprise any system configured to convert AC to DC, which may be more suitable for use by the energy storage module 110. In some embodiments, an input of the rectifier 210 may be electrically coupled with the supply input 105. In some embodiments, the electrical coupling to the supply input 105 is accomplished by electrically coupling the input of the rectifier 210 to the output of the contactor 205. For example, the rectifier 210 may convert an AC source coupled to the supply input 105 into a 208V DC.

The power storage and delivery system 100 may comprise an active power factor correction and DC-DC conversion module 215 (“APFC/DC module”). The APFC/DC module 215 may comprise any system configured to affect and/or maintain the waveshape of the electric current drawn from the source of electric current to improve the power factor of the drawn electric current. For example, the APFC/DC module 215 may comprise an active power factor correction circuit configured to allow the waveshape of the electric current drawn from an AC source to remain sinusoidal and in phase with the voltage.

The APFC/DC module 215 may also comprise any system configured to convert an input DC at a first voltage to an output DC at a second voltage. In one embodiment, the APFC/DC module 215 may comprise an active power factor correction circuit and a DC-DC conversion circuit, wherein an output of the active power factor correction circuit may be electrically coupled with an input of the DC-DC conversion circuit. For example, the active power factor correction circuit may be configured to maintain a constant 208V DC on its output, and the DC-DC conversion circuit may be configured to convert a 208V DC on its input to a 400V DC on its output. In one embodiment, an input of the active power factor correction circuit may be electrically coupled with the APFC/DC module 215 input, and an output of the DC-DC conversion circuit may be electrically coupled with the APFC/DC module 215 output. In one embodiment, the APFC/DC module 215 input may be electrically coupled with the rectifier 210 output, and the APFC/DC module 215 output may be electrically coupled with an input of the energy storage module 110. In one embodiment, the APFC/DC module 215 may comprise only a DC-DC conversion circuit.

The APFC/DC module 215 may comprise discrete circuits and/or devices providing the active power factor correction and DC-DC conversion functions. The APFC/DC module 215 may comprise a circuit and/or device providing both the active power factor correction and DC-DC conversion functions. For example, the APFC/DC module 215 may comprise a boost circuit designed to draw sinusoidal current in phase with the voltage, wherein the boost circuit may also be configured to provide a DC-DC conversion function.

In an exemplary embodiment, a power storage and delivery system 100 comprises a supply input 105 electrically coupled with a contactor 205 input, a contactor 205 output electrically coupled with a rectifier 210 input, a rectifier 210 output electrically coupled with a APFC/DC module 215 input, a APFC/DC module 215 output electrically coupled with an energy storage module 110 input, an energy storage module 110 output electrically coupled with a DC-AC inverter 115 input, and a DC-AC inverter 115 output electrically coupled with a mains output 120. The power electronics 130 may comprise the above components.

Still referring to FIG. 2, the power storage and delivery system 100 may comprise an output device 255. The output device facilitates the transfer of information to and/or from the power storage and delivery system 100 from and/or to a user of the power storage and delivery system 100. The output device 255 may be any system configured to present information in a form perceivable by a user of the power storage and delivery system 100. In some embodiments, the output device 255 may comprise a display device. The output device 255 may be communicatively linked with the controller 140. The controller 140 may be configured to determine any information corresponding to the power storage and delivery system 100, and may be configured to transmit the determined information to the output device 255. For example, the controller 140 may be configured to determine information relating to the usage and health of the power storage and delivery system 100 based on the information communicated to the controller 140 by the various components of the power storage and delivery system 100, such as the DC-AC inverter and/or the energy storage module 110, may be configured to transmit the determined information to a display device composing the output device 255. For further example, the controller may be configured to transmit information to the output device 255 relating to electricity usage and cost statistics, past, present, and/or future utility rate information, status of any component of the power storage and delivery system 100, state of charge of the MCAP, charge, retention, and/or discharge status, whether one or more electric current sources are experiencing an unusual condition and/or other predetermined condition, and the like.

The output device 255 may comprise an input device configured to accept input from a user of the power storage and delivery system 100. In some embodiments, the output device 255 may comprise a touch screen configured to accept touch inputs by the user. In some embodiments, the output device 255 may comprise buttons configured to facilitate input by the user. The output device 255 may be configured to transmit any user input to the controller 140. The controller 140 may be configured in any suitable manner to accept and/or process the user input. For example, the user input may comprise an instruction to alter the operation of the power storage and delivery system 100, and the controller may be configured to appropriately control the various components of the power storage and delivery system 100 according to the instruction. In some embodiments, the output device 255 may only comprise an input device, such that no information may be presented to a user of the power storage and delivery system 100.

In an exemplary embodiment, a power storage and delivery system 100 may comprise an output device 255 communicatively linked with a controller 140, a communication interface 145 communicatively linked with the controller 140, and a CMS 150 communicatively linked with the controller 140. The control electronics 160 may comprise the above components.

Referring now to FIG. 3, a power storage and delivery system 100 according to various aspects of the present invention may be housed in a protective enclosure 300. The various components of the power storage and delivery system 100 may be situated in the protective enclosure 300 in a manner that facilitates their retention by the protective enclosure 300 as well as their removal from the protective enclosure 300. For example, the various components of the power storage and delivery system 100 may be situated on one or more cards 310, such as printed circuit boards, that are retainable by the protective enclosure 300. The cards 310 may physically and electrically connect to a slot connector (not shown), similar in purpose to those used to connect a computer expansion card to a local computer bus. The cards 310 may be electrically coupled with each other through one or more slot connectors. The slots may provide physical retention of the one or more cards 310. The cards 310 may be configured to be physically retained by the protective enclosure through the use of a screw and/or other fastening device.

In an exemplary embodiment, one or more first cards 320 comprise the energy storage module 110. For example, the first cards 320 may comprise one or more MCAPs. A second card 325 may comprise the DC-AC inverter 115. A third card 315 may comprise the remaining components of the power storage and delivery system 100, such as the control electronics. In some embodiments, the third card 315 may comprise the contactor 205, rectifier 210, and/or APFC/DC module 215. In some embodiments, the protective enclosure 300 comprises empty spaces 305 configured to accept additional cards 310. For example, the protective enclosure 300 may comprise additional slot connector configured to accept additional first cards 320, for example to allow an increase of the storage capacity of the power storage and delivery system 100. In some embodiments, the various cards 310 may be removable to facilitate their replacement. For example, if a card 310 is damaged, it may be removed from the protective enclosure 300 and replaced with a new card 310.

The protective enclosure 300 may comprise a weatherproof, electrically certified enclosure. The protective enclosure 300 may comprise vents 340 and/or fans to provide cooling to the various components of the power storage and delivery system 100. The protective enclosure 300 may comprise one or more openings 350 configured to facilitate the electrical connection of a source of electric current to the power storage and delivery system 100, and/or configured to facilitate the electrical connection of the power storage and delivery system 100 to the electric current input of a property or structure.

FIGS. 4A-4C representatively illustrate various configurations of systems comprising the power storage and delivery system 100. FIG. 4A representatively illustrates a power storage and delivery system 100 coupled between a DC source 405 and a circuit breaker panel 415 of a property or structure. The DC source 405 may be any source of DC, such as a solar panel, battery, and the like. The DC source 405 is electrically coupled with an input of the power storage and delivery system 100, such as the supply input 105. An output of the power storage and delivery system 100, such as the mains output 120, is electrically coupled to the circuit breaker panel 415.

FIG. 4B representatively illustrates a power storage and delivery system 100 coupled between an AC source 420 and the circuit breaker panel 415. The AC source 420 may be any source of AC, such as mains AC supplied by an electric utility. The AC source 420 is electrically coupled with an input of the power storage and delivery system 100, such as the supply input 105. An output of the power storage and delivery system 100, such as the mains output 120, is electrically coupled to the circuit breaker panel 415.

FIG. 4C representatively illustrates a power storage and delivery system 100 coupled between an AC source 420 and the circuit breaker panel 415, as well as a DC source 405 and the circuit breaker panel 415. The power storage and delivery system 100 may comprise a plurality of supply inputs 105, each suitably configured to accept a separate source of electric current. A first supply input may be configured to accept the source of AC, and a second supply input may be configured to accept a source of DC. The AC source 420 may be electrically coupled with the first supply input, and the DC source 405 may be electrically coupled with the second supply input. The power storage and delivery system 100 may be configured to allow the DC supplied by the DC source to bypass the rectifier 210. An output of the power storage and delivery system 100, such as the mains output 120, may be electrically coupled to the circuit breaker panel 415.

A method for manufacturing a power storage and delivery system 100 may comprise electrically coupling an output of a DC-AC inverter 115 with a mains output 120 configured to deliver an electric current, such as mains electricity, electrically coupling an input of an energy storage module 110 with a supply input 105 configured to accept the source of electric current, electrically coupling an output of the energy storage module 110 with an input of the DC-AC inverter 115, communicatively linking the energy storage module 110 with a CMS 150, electrically coupling the DC-AC inverter 115 with a controller 140, and communicatively linking the CMS 150 with the controller 140. The method may comprise communicatively linking a communication interface 145 with the controller 140.

The method for manufacturing a power storage and delivery system 100 may further comprise electrically coupling an input of a rectifier 210 with the supply input 105, and electrically coupling an output of the rectifier 210 with an input of the energy storage module 110. The method alternatively comprise electrically coupling an input of the rectifier 210 with the supply input 105, electrically coupling an output of the rectifier 210 with an input of an APFC/DC module 215, and electrically coupling an output of the APFC/DC module 215 with an input of the energy storage module 110. The method may further comprise electrically coupling an output of a contactor 205 with an input of the rectifier 210, electrically coupling an input of the contactor 205 with the supply input 105, and electrically coupling the controller 140 with the contactor. The method may further comprise arranging an output sensor to substantially measure the electric current output via the mains output 120, and electrically coupling the output sensor with the controller 140. The method may further comprise arranging an input sensor to measure the electric current received via the supply input 105, and electrically coupling the input sensor with the controller 140.

A method for installing the power storage and delivery system 100 may comprise electrically coupling a source of electric current with the supply input 105, and electrically coupling the mains output 120 with an electric current input of a structure, such as a circuit break panel of the structure configured to accept mains electricity.

Referring now to FIG. 5, a method for accepting at least one source of electric current and supplying the entire electric current needs of a structure for multiple days without the assistance of another source of electric current may comprise receiving a first electric current (505) from the source of electric current, controlling a magnetic capacitor to collect a charge from the first electric current (510), controlling the magnetic capacitor to retain the charge (515), controlling the magnetic capacitor to release the charge (520), and outputting to the structure a second electric current derived from the released charge (525).

Receiving a first electric current (505) may comprise any suitable system or method for inputting a source of electric current. In an exemplary embodiment, receiving a first electric current (505) may comprise receiving an electric current from an electrical coupling, such as using a supply input 105. In some embodiments, receiving a first electric current (505) may comprise receiving an electric current from the source of electric current using the electrical coupling. The first electric current may comprise AC or DC. The first electric current may comprise a plurality of sources of AC and/or DC electric current. In some embodiments, for example when the first electric current comprises AC, receiving a first electric current (505) may comprise rectifying the first electric current. In some embodiments, receiving a first electric current (505) may comprise passing the first electric current (whether or not rectified) through an active power factor correction circuit and/or a DC-DC conversion circuit, which have been previously described. In some embodiments, receiving a first electric current (505) may comprise disconnecting from the source of electric current, such as by using a contactor 205.

Controlling the magnetic capacitor to collect a charge from the first electric current (510), controlling the magnetic capacitor to retain the charge (515), and controlling the magnetic capacitor to release the charge (520) may comprise any suitable system or method for electrically coupling the first electric current to one or more MCAPs. Controlling the magnetic capacitor to collect (510), retain (515), and release (520) charge may comprise providing control signals to the MCAP to cause the MCAP to collect, retain, and/or release energy derived from the first electric current. Exemplary control signals have been previously described.

Controlling the magnetic capacitor to collect (510), retain (515), and release (520) charge may comprise any suitable system or method for determining when to collect, retain, and release energy from one or more MCAPs. For example, a controller 140 may receive, detect, or otherwise determine information about the status and usage of the power storage and delivery system 100, and may accordingly decide to cause the MCAP to collect, retain, or release energy. Exemplary decisions of when to collect, retain, and release energy have been previously described. For further example, a controller 140 may receiving, using a communications interface 145, information corresponding to the cost of the electric current provided by the source of electric current, and may determine one or more time periods in which it is most desirable to collect, retain, or release energy from the MCAP. In some embodiments, the controller may determine when to collect, retain, or release energy from the MCAP based on input from a user. The input may, for example, be received from the output device 255 previously described. Controlling the magnetic capacitor to collect (510), retain (515), and release (520) charge may further comprise determining whether to provide an electric current to the structure from the MCAP or from the source of electric current.

Outputting a second electric current derived from the released charge to a structure (525) may comprise any suitable system or method for delivering the released charge to an electrical coupling, such as a mains output 120. In an exemplary embodiment, outputting a second electric current (525) may comprise passing the second electric current through a DC-AC inverter to convert the second electric current AC, and delivering the second electric current to the electrical coupling. Outputting a second electric current (525) may further comprise delivering the second electric current to an electric current input of the structure using the electrical coupling.

In some embodiments, a method for accepting at least one source of electric current and supplying the entire electric current needs of a structure for multiple days without the assistance of another source of electric current may further comprise outputting information corresponding to the power storage and delivery system 100 to a user. In some embodiments, information may be output to an output device 255. In some embodiments, information may be output using the communication interface 145.

In the foregoing specification, the invention has been described with reference to specific exemplary embodiments. Various modifications and changes may be made without departing from the scope of the present invention as set forth in the exemplary embodiments. The specification and figures are to be regarded in an illustrative manner, rather than a restrictive one and all such modifications may be included within the scope of the present invention. For example, the steps recited in any method or process embodiments may be executed in any appropriate order and are not limited to the specific order presented in the embodiments. Additionally, the components and/or elements recited in any apparatus embodiment may be otherwise assembled or operationally configured to produce substantially the same result and are accordingly not limited to the specific configurations recited in the embodiments.

The communicative links described herein may provide one-way, two-way, and/or multi-way communication, and communication may comprise the one-way, two-way, and/or multiple-way transfer of information and/or other data. The communicative links described herein may comprise electrical couplings, wireless couplings, and the like. Further, the electrical couplings described herein may comprise wireless couplings.

Various benefits, advantages, and solutions to problems have been described with regard to particular embodiments. Any benefit, advantage, solution to problems, or any element that may cause any particular benefit, advantage, or solution to occur or to become more pronounced are not to be construed as critical, required, or essential features or components of any or all the embodiments.

Elements in the figures, drawings, images, etc. are illustrated for simplicity and clarity and have not necessarily been drawn to scale. For example, the dimensions of some of the elements in the figures may be exaggerated relative to other elements to help improve understanding of various embodiments of the present invention. Furthermore, the terms ‘first’, ‘second’, and the like herein, if any, are used for distinguishing between similar elements and not necessarily for describing a sequential or chronological order. Moreover, the terms ‘front’, ‘back’, ‘top’, ‘bottom’, ‘over’, ‘under’, and the like in the disclosure and/or in the provisional embodiments, if any, are generally employed for descriptive purposes and not necessarily for comprehensively describing exclusive relative position. Any of the preceding terms so used may be interchanged under appropriate circumstances such that various embodiments of the invention, for example, are capable of operation in configurations and/or orientations other than those explicitly illustrated or otherwise described.

The terms “comprises”, “comprising”, “including”, or any variation thereof, are intended to reference a non-exclusive inclusion, such that a process, method, article, composition, or apparatus that comprises one or more elements does not include only the elements recited, but may also include other elements not expressly listed or inherent to such process, method, article, composition or apparatus. Other combinations and/or modifications of the described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the disclosed invention.

1. A power storage and delivery system capable of accepting at least one source of electric current and capable of operating continuously as the sole provider of electric current for a structure for multiple days without the assistance of another source of electric current, comprising:
a supply input configured to accept the at least one source of electric current;
a mains output configured deliver mains electricity to the structure;
a DC-AC inverter, wherein a DC-AC inverter output is electrically coupled with the mains output;
an energy storage module, comprising:
an input electrically coupled with the supply input;
an output electrically coupled with a DC-AC inverter input; and
a magnetic capacitor electrically coupled with the energy storage module input and output and configured to:
collect energy received via the input of the energy storage module in response to a first signal;
retain the collected energy in response to a second signal; and
release the stored energy to the energy storage module output in response to a third signal;
a capacitor management system communicatively linked with the energy storage module and configured to provide the first, second, and third signals to the magnetic capacitor; and
a controller communicatively linked with the capacitor management system and electrically coupled with the DC-AC inverter, wherein the controller is configured to monitor the DC-AC inverter.

2. A power storage and delivery system according to claim 1, wherein:
the energy storage module comprises a second magnetic capacitor electrically coupled with the energy storage module input and output; and
the capacitor management system is configured to individually provide the first, second, and third signals to each magnetic capacitor.

3. A power storage and delivery system according to claim 1, wherein:
the energy storage module comprises a group of magnetic capacitors; and
the capacitor management system is configured to provide the first, second, and third signals to the group of magnetic capacitors.

4. A power storage and delivery system according to claim 1, further comprising:
a rectifier, wherein:
a rectifier output is electrically coupled with the input of the energy storage module; and
a rectifier input is electrically coupled with the supply input.

5. A power storage and delivery system according to claim 4, further comprising an active power factor correction circuit electrically coupled with the rectifier output and the input of the energy storage module.

6. A power storage and delivery system according to claim 4, further comprising a DC-DC conversion circuit electrically coupled with the rectifier output and the energy storage module input.

7. A power storage and delivery system according to claim 4, further comprising:
a contactor, wherein:
a contactor output is electrically coupled with the rectifier input;
a contactor input is electrically coupled with the supply input;
the contactor is configured to operate in response to a contactor control signal; and
the controller is electrically coupled with the contactor and configured to provide the contactor control signal.

8. A power storage and delivery system according to claim 1, further comprising an output sensor arranged to measure the electric current output via the mains output, wherein:
the output sensor is electrically coupled with the controller; and
the controller is configured to determine an amount of energy used by the structure based on the measured electric current output.

9. A power storage and delivery system according to claim 8, further comprising an input sensor arranged to measure the electric current received via the supply input, wherein:
the input sensor is electrically coupled with the controller; and
the controller is configured to determine an efficiency of the power storage and delivery system based on the measured electric current output and measured electric current received.

10. A power storage and delivery system according to claim 1, wherein the controller comprises a communication interface.

11. A power storage and delivery system according to claim 10, wherein the communication interface comprises a network interface.

12. A power storage and delivery system according to claim 10, wherein the controller is configured to:
access, via the communication interface, cost information corresponding to a source of electricity the supply input is configured to accept; and
cause the energy storage module to charge the magnetic capacitor during a predetermined period.

13. A power storage and delivery system according to claim 12, wherein:
the supply input is configured to accept a plurality of sources of electric current; and
the controller is configured to selectively cause the energy storage module to charge the magnetic capacitor, in a non-exclusive manner, from a particular source of electric current during the predetermined period.

14. A power storage and delivery system according to claim 12, wherein:
the supply input is configured to accept a plurality of sources of electric current; and
the controller is configured to selectively cause the energy storage module to charge the magnetic capacitor preferentially from the source of electric current having a preferred cost during a predetermined period.

15. A power storage and delivery system according to claim 1, further comprising an output device communicatively coupled with the controller, wherein the controller is configured to:
determine information corresponding to the operation of the power storage and delivery system; and
communicate the determined information to the output device.

16. A power storage and delivery system according to claim 15, further comprising an input device communicatively coupled with the controller, wherein the controller is configured to receive information from the input device.

17. A power storage and delivery system according to claim 15, wherein the controller is configured to:
generate a message in response to the source of electric current experiencing a predetermined event; and
communicate the message to the output device.

18. A power storage and delivery system according to claim 15, wherein the controller is configured to:
generate a message in response to the source of electric current experiencing a predetermined event; and
communicate the message to through the communication interface.

19. A power storage and delivery system according to claim 1, further comprising a protective enclosure configured to removably retain one or more cards, and wherein the energy storage module, capacitor management system, controller, and DC-AC inverter are situated on the one or more cards.

20. A power storage and delivery system according to claim 19, further comprising an active power factor correction circuit, a DC-DC conversion circuit, and a rectifier situated on the one or more cards.

21. A power storage and delivery system according to claim 1, wherein the first signal and the third signal comprise the same signal.

22. A method for accepting at least one source of electric current and supplying the entire electric current needs of a structure for multiple days without the assistance of another source of electric current, comprising:
receiving a first electric current from a supply input;
controlling a magnetic capacitor to collect a charge from the first electric current;
controlling the magnetic capacitor to retain the charge;
controlling the magnetic capacitor to release the charge; and
outputting a second electric current derived from the released charge to a mains output.

23. A method according to claim 22, wherein receiving the first electric current comprises receiving the first electric current from the at least one source of electric current electrically coupled with the supply input.

24. A method according to claim 22, wherein receiving the first electric current comprises rectifying the first electric current.

25. A method according to claim 22, wherein outputting the second electric current comprises outputting the second electric current to an electric current input of the structure coupled with the mains output.

26. A method according to claim 22, wherein outputting the second electric current comprises converting the second electric current to alternating current.

27. A method according to claim 22, further comprising:
retrieving information corresponding to the cost of the source of electric current; and
determining a time period in which to control the magnetic capacitor to charge from the first electric current based on the retrieved information.
